(19) United States
(12) Patent Application Publication
(10) Pub. No.: US 2025/0258653 A1
(43) Pub. Date: Aug. 14, 2025

(54) AUTOMATED USER STORY, AND ACCEPTANCE CRITERIA GENERATION FROM CUSTOMER CONVERSATION

(71) Applicant: Engineer.ai Global Limited, London (GB)

(72) Inventors: Sachin Dev Duggal, London (GB); Rohan Patel, London (GB)

(21) Appl. No.: 19/054,469

(22) Filed: Feb. 14, 2025

Related U.S. Application Data
(60) Provisional application No. 63/553,543, filed on Feb. 14, 2024.
(60) Provisional application No. 63/553,546, filed on Feb. 14, 2024.

(51) Int. Cl. G06F 8/10

(52) U.S. Cl. CPC G06F 8/10

(57) ABSTRACT

A software development platform providing an integrated resource for design, development, and purchase of customer-desired software applications for software projects created by customers. The platform comprising one or more computers configured using computer readable instructions stored in non-transitory computer memory to provide the software development platform. Code generation process or system can be provided that is implemented as part of the platform or as a separate system for supporting such systems. The system can include automated generation of user stories and customer acceptance criteria using machine learning integration.

### CROSS REFERENCE TO RELATED APPLICATIONS

This application claims priority to U.S. Provisional Patent Application Ser. No. 63/553,543, filed Feb. 14, 2024, and U.S. Provisional Patent Application Ser. No. 63/553,546, filed Feb. 14, 2024, the entirety of each of which is herein incorporated by reference in their entirety.

### FIELD OF THE INVENTION

Embodiments of the present invention relate to the field of software development. Specifically, embodiments of the present invention are related to advanced development platforms or systems including or incorporating machine learning models to develop and generate source code and related aspects for planned or desired software applications.

### BACKGROUND

The present invention relates to software application development systems and improving the effectiveness, speed, and operation of software application development. Software development is its own field of endeavor and a significant industry exists directed to software development tools and software development. Typically, a company seeking a new application can engage a software developer to develop the new software application for based on specifications or other methodology.

As generally understood, the conventional approach for developing a custom software application is to engage designers to develop the interface designs and the visual components (e.g., wireframes), and have software developers to implement the customer requirements for the software application including the design aspect into working source and object code (e.g., adapted for selected operating systems). The interactions with the software developer may involve initial conversations, artwork, or input from designers, source code developers, and customers.

This process can often times result in projects failing to meet objectives because of the complexity and their extended time for development. Techniques for improvement and automation of this process, which can improve the design and development process and provide greater efficiencies such as speed of operation and accuracy for vendors and customers, are desired.

Conventional systems lack robustness in the provided tools that can reliably improve the design creation of a new customer application and improve the efficiency of the build such as by automatically relying on previously developed code, testing, automated operations and adaptations, or other advanced tools and features that solve deficiencies in the code generation process.

Overall, there can be one or more technical problems related to software development.

### SUMMARY OF THE INVENTION

According to embodiments of the present invention, one or more software development and code generation systems are illustratively provided. For example, a computer implemented source code generation system can be configured to automatically generate source code blocks, comprising: a computer configured to include: a feature database comprising a plurality of predefined features, wherein a predefined feature is an independent unit of predefined functionality that is a basic building block for software applications; a source code block database of precomposed source code blocks, wherein within the architecture of the system, predefined features are implemented with one or more corresponding source code blocks; a user story database comprising individual user stories each generated for a corresponding feature selected to be included in a user's project to build the user's desired custom software application; wherein the computer is configured to automatically generate a block summary of individual source code blocks that is configured to produce information about the intrinsic structure and operation of the source code block under its operation, wherein the computer is configured to automatically generate an implementation plan that determines which functionality is to be added to which one of the precomposed source code blocks by processing the corresponding (generated) block summary for a feature and the implementation plan, which was created as a function of the user story.

A computer implemented code generation system, can, for example, be implemented, comprising: a computer configured to include, a user story database comprising individual user stories each generated for a corresponding feature selected to be included in a user's project to build the user's desired custom software application, and wherein the computer is configured to automatically process the user story to generate test cases that validate one or more elements of functionality represented by contents of a user story.

In another example, a computer implemented code generation system can be provided comprising, a computer configured to include: a feature database comprises a plurality of predefined features, wherein a predefined feature is an independent unit of predefined functionality that is a basic building block for software applications; a source code block database of precomposed source code blocks, wherein within the architecture of the system, predefined features are implemented with one or more corresponding source code blocks; a user story database comprising individual user stories each generated for a corresponding feature selected to be included in a user's project to build the user's desired custom software application, wherein the computer is configured to automatically generate a block summary of individual source code blocks that is configured to produce information about the intrinsic structure and operation of the source code block under its operation, and wherein the computer is configured to retrieve a particular user story corresponding to a feature for a particular customer's desired custom software application and a block summary that summarizes a corresponding source code block for that feature, and automatically determines a needed augmentation or modification to adapt the corresponding source code block to the user story.

Also for example, a computer implemented source code generation system can be provided comprising: a computer configured to include code generation process that automatically generates modified versions of precomposed source code blocks by creating one or more prompts to a large language model that in response, generates an output comprising the modified source code blocks, and is further configured to perform automatic tests that validate the source code blocks, wherein the automatic tests generate one or more errors arising from the automatic test, and wherein the computer is configured to use the error code(s) with the modified version of the precomposed source code block to generate a further modified version of the precomposed source code block.

Also for example, a software development system for assisting users seeking a custom software application can be provided, comprising, a computer configured to track user interactions with the customer in connection with the customer communicating the customer's desired software applications and determine one or more predefined features, for the application, determined to be reflected in the interactions, generate feature notes about the one or more determined features from the interaction, and automatically generate one or more user stories from the generated feature notes for the corresponding predefined feature.

Additional or different inventions and embodiments of inventions are described herein.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 is a simplified block diagram of a distributed computer network according to an embodiment of the present invention.

FIG. 2 shows an exemplary computer system such as a client system according to an embodiment of the present invention.

FIG. 3 illustrates a functional block diagram of an online software development platform or system according to an embodiment of the present invention.

FIGS. 4-10 show illustrative functional block diagrams for implementing a code generation process according to an embodiment of the present invention.

FIG. 11 illustrates an interface of the software application according to an embodiment of the present invention.

FIG. 12 illustrates an interface for using templates in the design process according to an embodiment of the present invention.

FIG. 13 illustrates an interface for using a problem/problem group in the design process according to an embodiment of the present invention.

FIG. 14 illustrates one type of interface or interaction with the user in which the platform provides one or more feature recommendations to the user according to an embodiment of the present invention.

FIG. 15 is a simplified block diagram of an embodiment of a system for creating software in accordance with one or more embodiments.

FIG. 16 is a display screen that provides an example of an implementation that permits a human product assistant to document notes for a project and save the notes in accordance with one or more embodiments.

FIG. 17 provides an illustrative example of a manually generated user story that is representative of an automatically generated user story in accordance with one or more embodiments of the present invention.

Certain examples and embodiments have other features that are one of in addition to and in lieu of the features illustrated in the above-referenced figures. These and other features are detailed below with reference to the above-referenced figures.

### DETAILED DESCRIPTION OF THE INVENTION

Embodiments of the present invention disclose a system and method that automate aspects of developing software applications. A software development platform (sometimes referred to as a system) can be configured to include an interactive online interface for receiving a customer software application project and engage in that process to completion. The platform can provide an engagement process in which the customer through interactive software interactions (or possibly sometimes human interaction in some instances) can specify the functionality and operating characteristics of the desired software application. The platform can include selected features, manually or automatically, that work through the software development process with the customer and is configured to operate to develop the software.

The platform can handle different types or categories of applications and be configured to accept, for example, many projects. Embodiments of the present invention can provide improvements in speed such as to provide real time responses (e.g., source code generation from features and existing source code) that are not otherwise possible using conventional solutions in this field of technology (software development platforms). This incorporation materially improves the functionality of the platform and the development process through capitalizing in identifying valuable pathways and interrelationships that are, for example, already part of the stored knowledge of the system.

As illustrated herein through examples and illustrative embodiments, the added components can allow the platform to automatically and in a uniformly consistent way ingest customer desired software information (e.g., in natural language processing using text and/or spoken communications with customers on the system) in the software development process as carried out through the platform.

The platform can be a cloud service that permits the user to interact with the platform through graphical user interfaces to complete the different stages of the application development process. That would generally be understood to involve a combination of one or more computers, software implemented on the one or more computers that configures the computers to provide a specialized application, and online, Internet website access, to the functionality through a (conventional) browser or in some cases, a software application (e.g., a mobile app). The platform or system can be structured to define features as individual elements having certain characteristics such as metadata. A feature is further defined herein.

In preferred embodiments, the platform is an online software development platform that is used by the public to engage a company to develop a particular software application for the customer. An example of such a system is illustratively described in U.S. Patent Publication No. 20180107459, by Duggal et al., filed Oct. 17, 2017, which is incorporated herein by reference in its entirety. The platform is preferably be configured to provide the user, a potential customer, with the ability to interact with different interactive user interfaces (display screens, which can refer to a portion of a displayed screen or graphical user interface) to intuitively specify the requirements for the desired custom software application. The platform can be configured to operate as an application in object code that interacts with the user. The platform preferably includes a repository of existing source code for individual features that have been previously collected, used and/or tested to implement a corresponding feature. This source code can be reused, modified or compiled during the software development to produce the actual software application sought by the user (customer). Thus, the system is configured to maintain different modes of a feature including one that is the source code for the actual feature for use in developed applications, and one that names the feature and defines associated metadata and/or links (e.g., connect using pointers to other features).

The platform can also include a subsystem that communicates with a set of third party software developers to communicate the requirements (e.g. via electronic messaging) and to engage the developers to develop additional source code or desired modification(s) that after a query to the existing database of feature source code is determined to be needed or unavailable in the repository, thus requiring the developers to create new code for requirements or selections that are not in the repository (which is communicated via the platform).

The platform can also communicate the requirements internally via electrical communications and in response automatically generate or assemble source code that contains the source code for the selected features from the repository. The repository can store different versions of the source code such as for different operating system or different end use platforms (e.g., mobile phones versus laptops). As part of the software development process, the platform can display interfaces that require the user to select the operating system and end user platform. If desired, the platform takes that selection into account in generating or assembling source code for a customer's actual application.

The platform can be configured to allow the user to select the desired features as a preliminary step in order to specify the requirements for the desired custom software application (the scope of the software project).

The platform can therefore be configured for the user to perform the design process or a portion thereof, e.g., on its own without the need to involve designers or third party user interface design applications, and to have a general initial (mutual) understanding of expectation and scope through this process. The platform can preferably provide the user with an integrated resource for design with a streamlined process for software development where there is preexisting common structure between design and development such as by way of correspondence between features and corresponding source code, for the actual software, that is part of the platform.

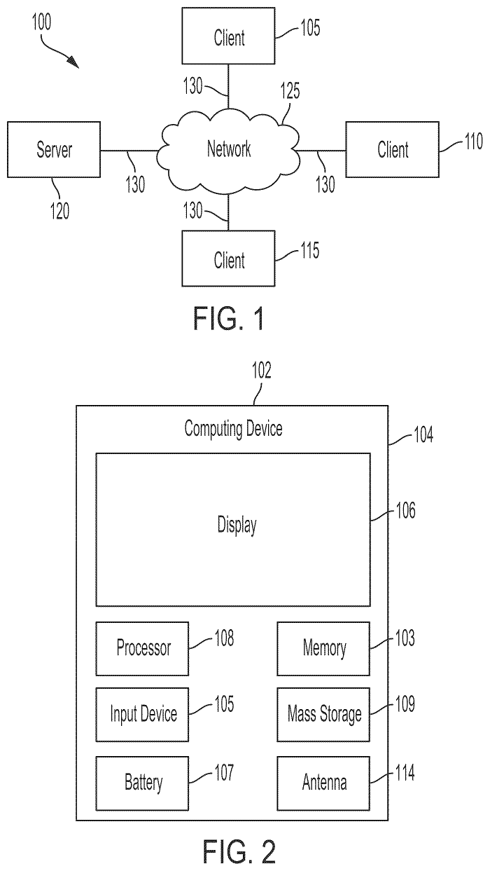

FIG. 1 is a simplified block diagram of a distributed computer network 100 incorporating an embodiment of the present invention. Computer network 100 includes a number of client systems 105, 110, and 115, and a server system 120 coupled to a communication network 125 via a plurality of communication links 130. Communication network 125 provides a mechanism for allowing the various components of distributed network 100 to communicate and exchange information with each other.

Communication network 125 may itself be comprised of many interconnected computer systems and communication links. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 125 is the Internet, in other embodiments, communication network 125 may be any suitable communication network including a local area network (LAN), a wide area network (WAN), a wireless network, an intranet, a private network, a public network, a switched network, Internet telephony, IP telephony, digital voice, voice over broadband (VoBB), broadband telephony, Voice over IP (VOIP), public switched telephone network (PSTN), and combinations of these, and the like.

System 100 in FIG. 1 is merely illustrative of an embodiment and does not limit the scope of the systems and methods as recited in the claims. One of ordinary skill in the art would recognize other variations, modifications, and alternatives. For example, more than one server system 120 may be connected to communication network 125. As another example, a number of client systems 105, 110, and 115 may be coupled to communication network 125 via an access provider (not shown) or via some other server system. An instance of a server system 120 and a computing device 105 may be part of the same or a different hardware system. An instance of a server system 120 may be operated by a provider different from an organization operating an embodiment of a system for specifying an object in a design, or may be operated by the same organization operating an embodiment of a system for specifying an object in a design.

Client systems 105, 110, and 115 typically request information from a server system which provides the information. Server systems by definition typically have more computing and storage capacity than client systems. However, a particular computer system may act as both a client and a server depending on whether the computer system is requesting or providing information. Aspects of the system may be embodied using a client-server environment or a cloud-cloud computing environment.

Server 120 is responsible for receiving information requests from client systems 105, 110, and 115, performing processing required to satisfy the requests, and for forwarding the results corresponding to the requests back to the requesting client system. The processing required to satisfy the request may be performed by server system 120 or may alternatively be delegated to other servers connected to communication network 125.

Client systems 105, 110, and 115 enable users to access and query information or applications stored by server system 120. Some example client systems include portable electronic devices (e.g., mobile communication devices) such as the Apple iPhone®, the Apple, or any device running the Apple iOS™, Android™ OS, Google Chrome OS §, Windows OS, or Windows Mobile® OS. In a specific embodiment, a “web browser” application executing on a client system enables users to select, access, retrieve, or query information and/or applications stored by server system 120. Examples of web browsers include the Android browser provided by Google, the Safari® browser provided by Apple, the Opera Web browser provided by Opera Software, and Internet Explorer Mobile browsers provided by Microsoft Corporation, the Firefox® and Firefox for Mobile browsers provided by Mozilla®, and others.

FIG. 2 shows an exemplary computer system such as a client system of embodiments of the present invention. In an embodiment, a user interfaces with the system through a client system, such as shown in FIG. 2. Mobile client communication or portable electronic device 102 includes a display, screen, or monitor 106, housing 104, and input device 105. Housing 104 houses familiar computer components, some of which are not shown, such as a processor 108, memory 103, battery 107, speaker, transceiver, antenna 114, microphone, ports, jacks, connectors, camera, input/output (I/O) controller, display adapter, network interface, mass storage devices 109, and the like. Computer system 102 may include a bus or other communication mechanism for communicating information between components. Mass storage devices 109 may store a user application and system software components. Memory 103 may store information and instructions to be executed by processor 108.

Input device 105 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, gestural interface (contact or non-contact gestures), biometric input sensors, or combinations of these.

Mass storage devices 109 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

System 100 may also be used with computer systems having different configurations, e.g., with additional or fewer subsystems. For example, a computer system could include more than one processor (i.e., a multiprocessor system, which may permit parallel processing of information) or a system may include a cache memory. The computer system shown in FIG. 2 is but an example of a computer system suitable for use. Other configurations of subsystems suitable for use will be readily apparent to one of ordinary skill in the art. For example, in a specific implementation, the computing device is mobile communication device such as a smartphone or tablet computer. Some specific examples of smartphones include the Droid Incredible and Google Nexus One®, provided by HTC Corporation, the iPhone® or iPad®, both provided by Apple, and many others. The computing device may be a laptop or a netbook. In another specific implementation, the computing device is a non-portable computing device such as a desktop computer or workstation.

A computer-implemented or computer-executable version of the program instructions useful to practice the present invention may be embodied using, stored on, or associated with computer-readable medium. A computer-readable medium may include any medium that participates in providing instructions to one or more processors for execution. Such a medium may take many forms including, but not limited to, nonvolatile (nontransitory), volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice embodiments of the present invention may be stored or reside in RAM or cache memory, or on mass storage device 240. The source code of this software may also be stored or reside on mass storage device 240 (e.g., flash drive, hard disk, magnetic disk, tape, or CD-ROM). As a further example, code useful for practicing embodiments of the invention may be transmitted via wires, radio waves, or through a network such as the Internet. In another specific embodiment, a computer program product including a variety of software program code to implement features of embodiments of the invention is provided.

Computer software products (sought by users) may be coded in any of various suitable programming languages, such as C, C++, C#, Pascal, Fortran, Perl, Matlab (from Math Works, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 7, Windows CE, Windows Mobile, Windows Phone 7), Linux, HP-UX, UNIX, Sun OS, Solaris, Mac OS X, Alpha OS, AIX, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the invention using a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

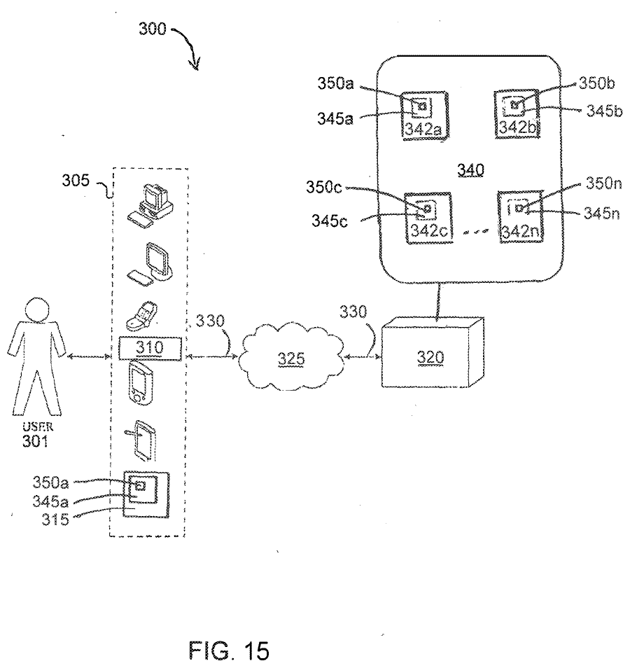

FIG. 15 is a simplified block diagram of an embodiment of a system 300 for creating software for use by a user 301. System 300 includes one or more user computing devices 305, and a server 320, coupled to a communication network 325 via a plurality of communication links 330. Computing device 305 may be used to run a user application 310 for creating software from existing code and new code and/or for communicating via electronic communications (e.g., email, chat, online conference, etc.) to communicate a customer's software application requirements, characteristics, aesthetic, functionality, and/or operation. System 300 can be configured to include natural language processing, such as in server 320, to operate and interact with a user through electronic communications such as chat messages. This can for example include a chatbot or automated assistant implemented using server 320. User application 310 may use computing device 305 and network 325 to access server 320. Communication network 325 (or “network 325”) provides a mechanism for allowing the various components of system 300 to communicate and exchange information with each other via communication links 330. Server 320 may include or have access to a database 340 of code libraries 342a, 342b, . . . , 342n. Each code library includes software code (not shown) from which system 300 may select to create customized software. Each code library 342a, 342b, . . . , 342n may have selected from it a subset of code sections 345a, 345b, . . . , 345n, which server 320 may assemble into customized software 350a, 350b, . . . , 350n and provide to user 301 via computing device 305. Customized software may be complete or may need to be augmented with additional custom code sections that may be newly created by partner developers.

Network 325 may be any suitable communications network. Communication network 325 may itself be comprised of many interconnected computer systems and communication links. As an example and not by way of limitation, one or more portions of network 325 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another suitable network, or a combination of two or more of these. Network 325 may include one or more networks 325.

Connections 330 may connect computing device 305 and server 320 to communication network 325 or to each other. Communication links 330 may be hardwire links, optical links, satellite or other wireless communications links, wave propagation links, or any other mechanisms for communication of information. This disclosure contemplates any suitable connections 325. In particular embodiments, one or more connections 325 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 330 each include an ad hoc network, an intranet, an extranet, a VPN, a LAN, a WLAN, a WAN, a WWAN, a MAN, a portion of the Internet, a portion of the PSTN, a cellular telephone network, another suitable connection 330, or a combination of two or more such connections 330. Connections 330 need not necessarily be the same throughout system 300. One or more first connections 330 may differ in one or more respects from one or more second connections 330.

Server 320 may be a network-addressable computing system that can host one or more product databases 340. Server 320 may be responsible for receiving information requests from computing device 305 via user application 310, for performing the processing required to satisfy the requests, for generating responses (e.g., custom software 350a, . . . , 350n) to received inquiries, and for forwarding the results corresponding to the requests back to requesting computing device 305. Server 320 may store, receive, or transmit data and software, and information associated with the data and software (including user data). The processing required to satisfy the requests may be performed by server 320 or may alternatively be delegated to other servers connected to communication network 325. For example, other servers may host database 340, or have additional databases. Server 320 may be an intermediary in communications between a computing device 305 and another server system, or a computing device 305 may communicate directly with another server system. Server 320 may be accessed by the other components of system 300, for example, directly or via network 325. In particular embodiments, one or more users 301 may use one or more computer devices 305 to access, send data to, and receive data from server 320.

Computing device 305, connections 330, and network 325, enable user 301 to access and query information stored and applications run by server 320, such as database 340. Some example computer devices 305 include desktop computers, portable electronic devices (e.g., mobile communication devices, smartphones, tablet computers, laptops) such as the Samsung Galaxy Tab®, Google Nexus devices, Apple iPhone®, the Apple iPad®, Microsoft Surface®, or any device running the Apple IOS®, Android® OS, Google Chrome® OS, Windows Mobile® OS, Windows Phone, or Embedded Linux.

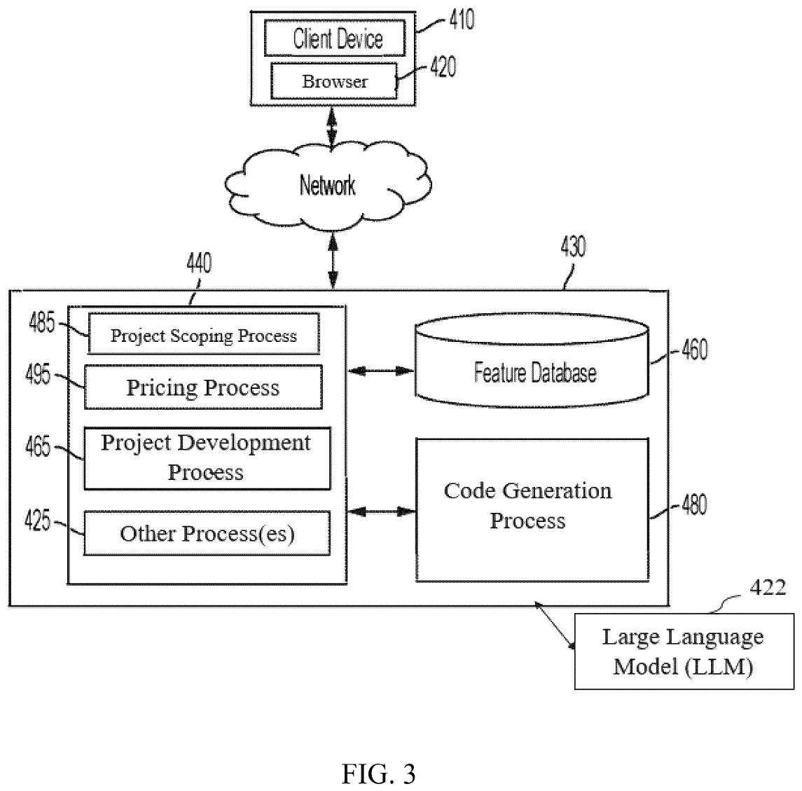

FIG. 3 illustrates a system for developing software according to an embodiment of the present invention. The system includes an application development software application 420 installed on an electronic device 410 and a builder software application 440 implemented on one or more servers 430. The electronic device 410 is preferably a desktop computer that can communicate with server via mobile networks or other wireless networks. Each of the electronic device and servers is a computer system that includes a microprocessor and volatile and non-volatile memory to configure the computer system. The computer system also includes a network connection interface that allows the computer system to communicate with another computer system over a network. Each software application may also be used independently or in conjunction with another software application to strengthen or supplement functionalities of the other software application.

The builder application 440 installed on the server 430 maintains a library of features for a software application. The library of features may be stored in a database 460. The builder application 440 is configured to transmit to the software development application on the client computer 410 the library of features, to receive a selection of a set of features.

The software development application 420 is configured to provide a graphical user interface that enables a customer to select and customize a set of features as part of building a software application for a customer's project. In some embodiments, the software development application 420 is a web application provided by the builder application on the server and configured to run in a conventional browser. In a preferred embodiment, the software development application is the conventional browser 420 configured to access an application development website provided by the server.

Feature database 640 can also include source code for each of the plurality of available features. The saved source code provides a repository of source code for available features that the platform can use to generate object code for the actual application (e.g., based on the selected operating system).

The builder application 440 is organized into a plurality of processes that together provide an implement a comprehensive platform for customers to design or specify project requirements, financial management of the process including determination or estimation of pricing, project management, customer relationship management, and other processes.

The builder application or platform 440 can provide an integrated resource for design, development, purchase, and delivery of customer-desired software applications for software projects created by customers. The software development platform is configured to implement a plurality of electronic operational domains providing user-interactive capabilities or internal functionality of the software development platform. The domains each comprising a process.

A process can be used to refer at a high level to an aspect of the software platform (one or more separate or integrated electronic operations) directed to a particular aspect or objective of the platform. As such, the software development platform is configured to implement a plurality of electronic operational domains providing user-interactive capabilities or internal functionality of the software development platform. The domains interact and together provide the platform.

As show in FIG. 3, application 440 includes project scoping process 485, pricing process 495, project development process 465, and other processes 425. The project scoping process 485 is configured to provide customers with the ability to specify the scope of the project. This can be done by way of user interfaces (or other interactions) that permit the user to select templates, features, and/or design characteristics or requirements for the project. A project scope process can be configured to provide a user with the ability through interacting with display screens to specify and accept a scope for the software project.

Pricing process 495 is configured to provide customers with a determination of the price for the components of the software project and/or delivery of the software application meeting the specified selections by the user as part of the project scoping process. The pricing process 495 is configured to provide prices for the delivery of a software application for the software project. The project development process 465 is configured to provide management and tracking of the software project once initiated. The discussion herein that encompasses the process functionality or is directed to achieving the process objective would be understood to be a part of that corresponding process. Builder application 440 can include code generation process 480. Code generation process 480 is configured to provide a code generation workflow and is configured to receive information and generate source code for a customer's desired software application with the use or incorporation of a machine learning system such as a Large Language Model 422. Other processes 425 can include the automated user story process illustratively described herein, the automated acceptance criteria process illustratively described herein, the tracker process illustratively described herein, and illustratively described processes that track or monitor electronic communications with customers and store the communications (which would include information representative thereof) to be used in other processes such as the user story generation process.

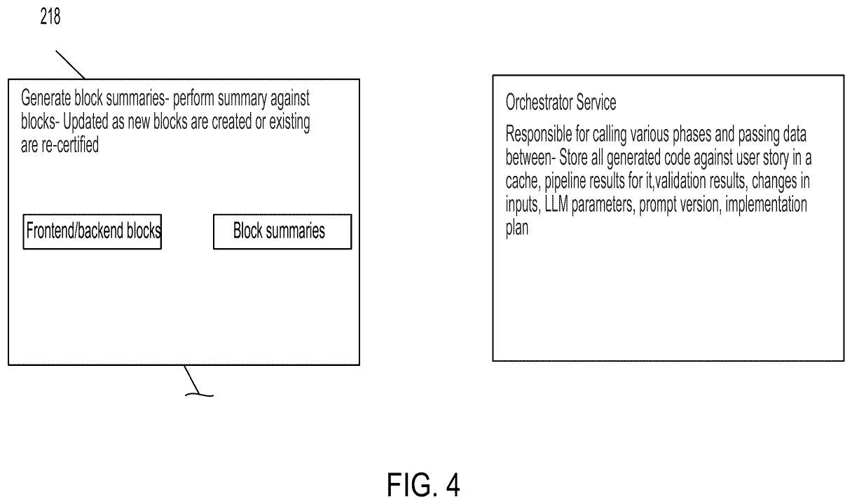

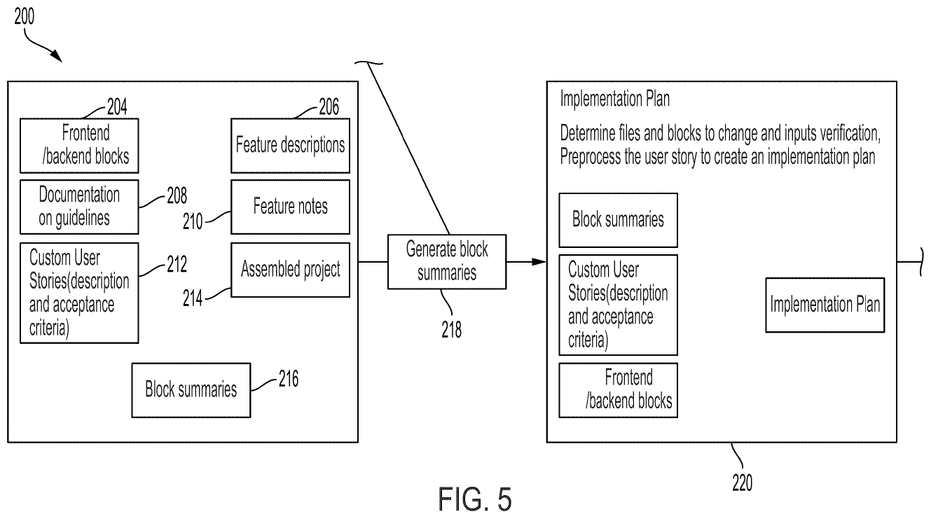

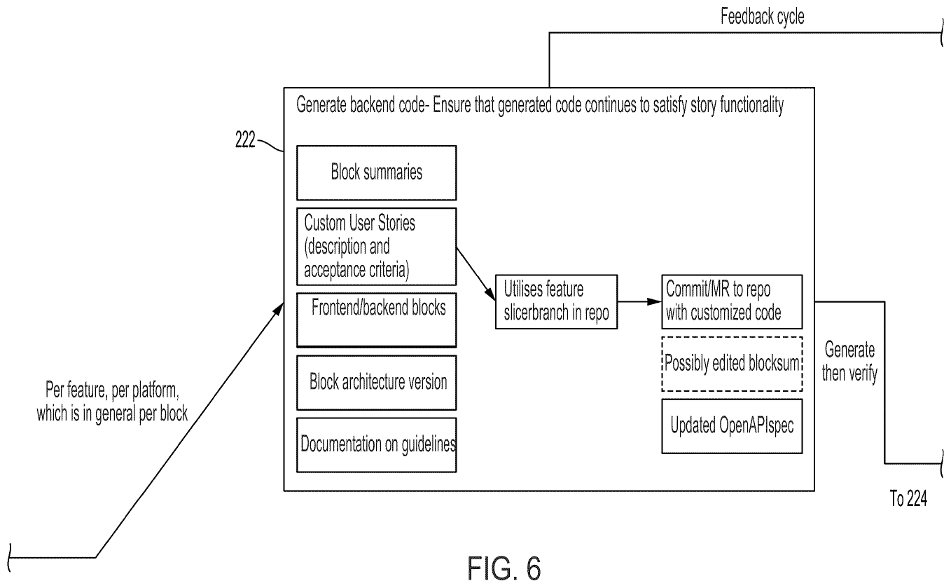

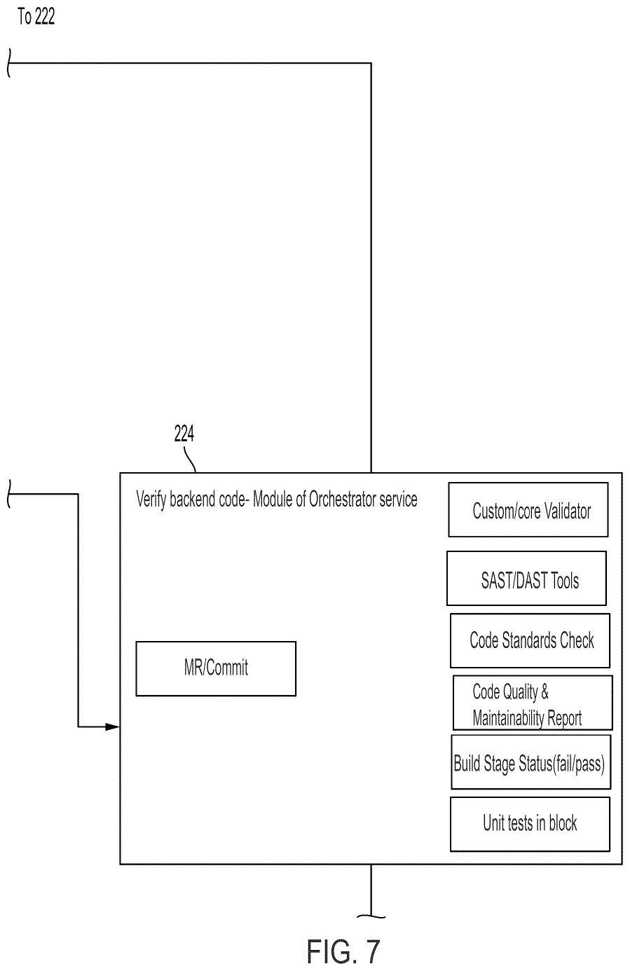

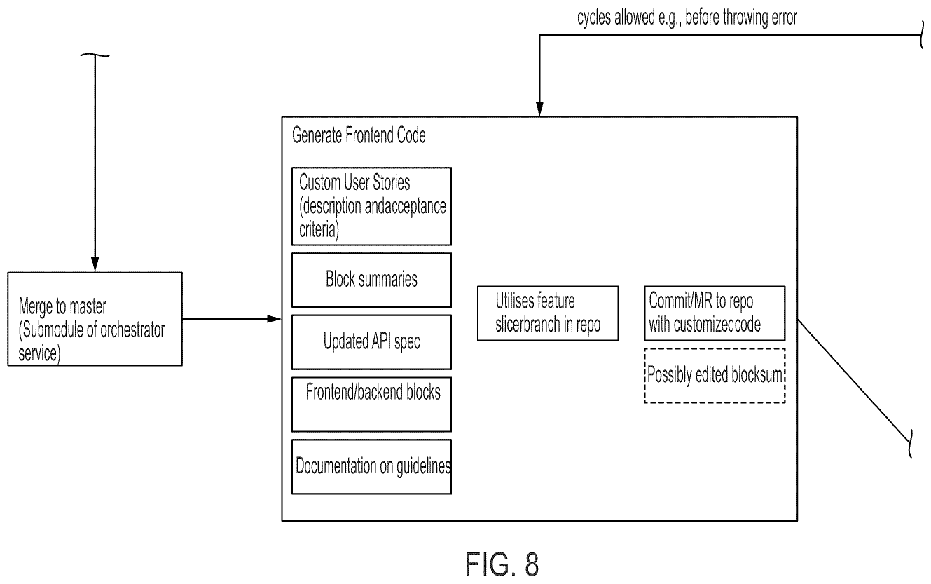

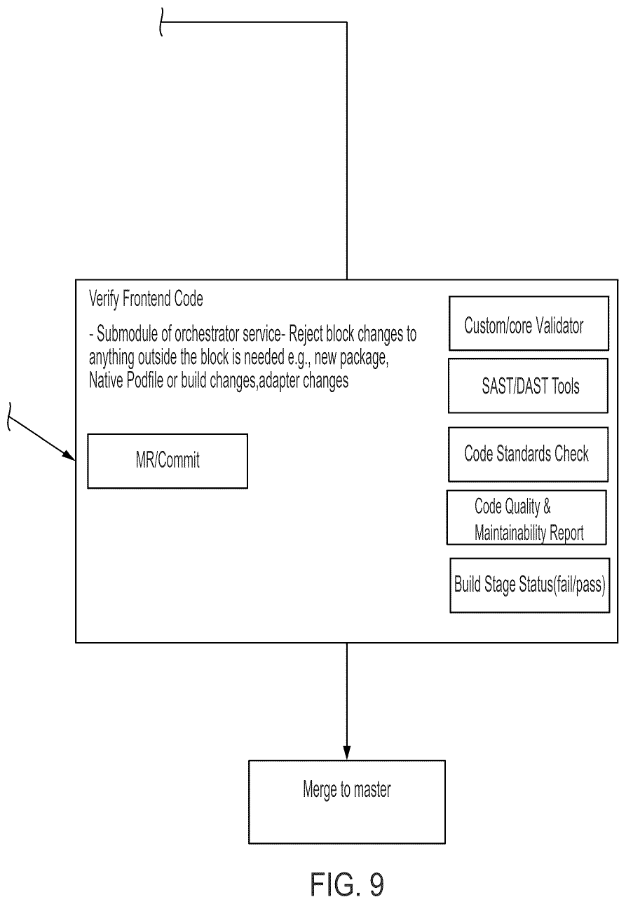

Code generation process 480 and related aspects are described illustratively in connection with FIGS. 4-10 and related text herein. A Large Language Model 422 is further described herein and can be configured to be part of the platform, builder application 440, such as being part of the domain or builder application 440 or can be external resource that is not under the same computer domain as the system or builder platform 440, or a combination thereof. Examples of an external resource can be publicly available LLMs such as the GPT series by OpenAI or Google Gemini. Communications with the LLM can be through electronic messages, e.g., as described herein.

Code generation processes for assisting users to capture and implement various requirements for a customers' desired custom applications are provided. Known code generation and automated custom software development technologies are improved by one or more embodiments herein involving automated code generation and/or related process(es) such as user story generation process(es), and acceptance criteria process(es) that provide more accurate and reliable generation processes (e.g., relative to other known automated systems or processes). The code generation process is configured to automatically generate a corresponding software application using a structured process comprising generating user stories, developing an implementation plan, and using a feedback system to generate and refine the corresponding software application. The system can for example be for use or incorporation in software design and development systems such as those illustratively described in U.S. Pat. No. 10,649,741, issued May 12, 2020, or U.S. patent application Ser. No. 17/348,695 filed Sep. 6, 2022, which are incorporated herein in their entirety. For example, the systems, methods, and computer readable medium illustratively described herein can be implemented in an overall system to automatically generate the source code for a custom software application for a customer.

For ease of discussion and brevity, the discussion herein sometimes (illustratively) describes the code generation process using the term the system because it is an element of the platform. The usage an also be understood to be referring to a part of a “larger” system such as a software development platform, illustratively described herein.

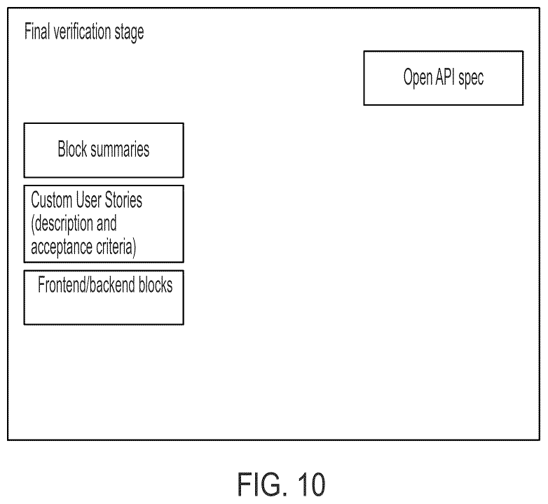

Now with reference to FIGS. 4-10, the system is configured to include and maintain structured data adapted for integrated operation of the code generation process. For example, databases 200 includes source code blocks 204, feature descriptions 206, documentation on guidelines 208, feature notes 210, custom user stories 212 (which may include description and acceptance criteria), assembled projects 214, and block summaries (216). Each database is defined using a corresponding data structure that is adapted to efficiently store and automatically operate within the code generation and testing process. Database 200 can be implemented to operate with builder application 440 for example as feature database 460 or can include feature database 460. Orchestrator service shown in FIG. 4 can be configured to provide a controller for the overall process in FIGS. 4-10. The orchestrator service can be configured to be responsible for calling various phases or processes provided in FIGS. 4-10 and passing data between them. The orchestrator service can be configured to store all generated code against user in a cache, pipeline results for the user story, validation results (e.g. performed in function block in FIG. 10), changes in inputs, LLM parameters, prompt version, and implementation plans.

Source code blocks 204 stores previously prepared sets of source code wherein each set corresponds to a source code block. A source code block is a previously prepared set of source code that is configured (and operable when executed in object form on a corresponding device/platform) to perform certain functionality (understood to include functionalities). For example, the certain functionality can be a feature.

A feature of the software application is a function (which can be one or more functions) for the application. Conceptually, the feature is the atomic unit of the software project. That is, a feature is an independent unit of predefined functionality that comprises the basic building block of the software. Accordingly, a feature is the smallest unit of the desired software application that the customer can employ (or need conceptualized). Further, a feature can be employed in disparate applications with or without change to its core functionality. This modular nature of the feature enables embodiments of the system to build a software application by connecting a selected set of features. In some embodiments, source code for the application may be collected or assembled (and saved). Embodiments of the overall custom software application development system thus enable the selection of a set of features to be automatically assembled into a working application.

Functionally, a feature includes one or more screens and the supporting behavior that are logically linked and provide a particular function or set of functions for the application. For example, for a mobile application, a feature's interface may comprise a single screen or a set of logically linked screens, each of which may be invoked from another screen of the set. For a desktop application, a feature's interface may comprise a screen, a set of screens, a frame embedded in a screen provided by another feature, or combinations thereof. Each screen of the feature may exhibit one or more display regions and one or more interactive regions. The display regions serve to display content whereas the interactive regions serve to interact with a user of the application, as will be described further in this specification. Metadata associated with each feature governs how each display region and interactive region of the feature connects to other features of the library of features. That is, a feature's metadata controls which other features it may call or be invoked by.

At the code level, a feature may be implemented by one or more blocks of software code. For example, a feature may represent a set of objects and data configured to provide a particular function or set of functions to the software application. Thus, the one or more blocks of code may be compiled into one or more object files corresponding to the feature during the software build. The object files may be linked with other object files of other features during the software build according to the configuration of each feature to provide executable code for the application. In the alternative, the feature may correspond to one or more object files or a combination of blocks of source code and object files. For example, a feature at the code level may represent a combination of pre-processor directives, source code, object code/files, included from various libraries, standard and otherwise.

A feature may include a functionality that can be implemented in a modular fashion and that can be interchangeable between multiple software applications. For example, a feature that requires a user of software application to login (or a login feature) can be implemented using the same code and screen or interface across multiple software applications. Other features may require the same core code across multiple applications and platforms but differ in details. For example, an Account Creation feature may differ in details from one application to another depending on the information that the account creation requires from the user.

Each feature provides an additional means to process data and/or interact with other applications and users.

Features of the software application may include for example, Account Creation, which enables the application to have users set up an account by filling out personal details on a form; Location, which provides the application access to the mobile device's location functions; or Push Notification, which enables the application to send notifications to users when the application is closed. Typically, features are grouped by types of features. For example, a bundle of features can be grouped as “Essentials” (which includes for example Account Creation, Search, and Login), a “Finance & Payments” set (which includes Payments, Centralized Billing, or Automatic Renewal), or a “Customer Insight Set” (e.g., Review or Polling features).

In some embodiments, a subset of the library of features may be organized in pre-organized sets called templates.

Source code blocks 204 are preferably defined to be in two groups, frontend and backend. Frontend source code blocks are a category in which the function of that block is for visible operation on the user's device (e.g., to make features available to the user of the device). Backend source code blocks are a category in which the function of the block is for operation “behind” the frontend. These functions support the operation of the frontend. Frontend and backend are generally known terms to those of ordinary skill in the art. This is structurally implemented such as by way of tags or databases to allow for automated retrieval and use within the system of the source code blocks.

Feature descriptions 206 are defined and stored in accordance with a feature description data structure. The information stated in the feature description describes a corresponding feature. The description is in machine-readable form at least by way of the data structure and corresponding structure definitions within the system. The feature descriptions include human readable text on the functionality provided by the feature.

The system can include or use an external configured machine learning model. A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems perform various types of statistical analyses, machine learning systems are distinguished from statistical analyses by virtue of the ability to learn without explicit programming and being rooted in computer technology.

A large language model (LLM) is a type of machine learning model designed for natural language processing tasks such as language generation. LLMs are language models with many parameters, and have been trained with self-supervised learning on a vast amount of text.

“Training” of a machine learning model may include building and/or updating a machine learning model from a sample dataset (referred to as a “training set”), evaluating the model against one or more additional sample datasets (referred to as a “validation set” and/or a “test set”) to decide whether to keep the model and to benchmark how good the model is, and using the model in a production environment to make predictions or decisions, or to generate content, based on new input data. This training is performed (e.g., only) before the LLM is used or incorporated into the code generation process or otherwise in the system. It may involve additional training such as when the LLM is an internal resource in the same domain as the code generation process or the platform.

The documentation on guidelines 208 are defined and stored in accordance with a documentation on guidelines data structure. The information stored in guidelines 208 defines the data, data types, and operational structure adapted to interface the process with a large language model (LLM). This includes the specification for automatically generating prompts for the LLM. This can include the specification for generating the prompt to have the LLM respond in a particular way and in a particular structure. The particular structure, as defined by the system, is adapted to operably communicate information to a subsequent process or operation. Thus, for example, providing an efficient process.

A code generation model can be used instead of or in combination with the LLM as used herein.

The feature notes 210 store the collected input from the customer on their requirements. They contain a description of the reusable source code block they are associated with, and the customer's required customizations to that block.

The custom user stories 212 are defined and stored in accordance with a defined custom user stories data structure. The information stored in custom user stories 212 defines the individual customer user stories. A user story is a description that represents the desired behavior of the application and the rationale for that behavior, in a defined and structured way that can be understood by human developers to generate corresponding source code and also adapted to be used within the system to automatically generate code by applying the user story to an automated code generation system. For example, the platform can include an artificial intelligence assistant that is configured to allow the user to interact with the assistant by typing in information such as in an online chat dialogue or speaking in natural language with the artificial intelligence assistant (e.g., through the microphone on the user's computer). The system is configured to receive such input and generate a custom user story from the received input for that user's desired custom software application. The custom user story is generated and stored in accordance with the custom user stories data structure such that information stored for the use story is automatically operable with other coordinating processes in the platform.

Block summaries 216 are machine generated summaries of source code blocks that are stored in accordance with a defined block summary data structure. The creation of information in a block summary is discussed below.

The system is configured to include engineered prompts (for an LLM) to summarize existing building blocks, which are composable software components. The block summarizer reverse-engineers the set of source code files that make up a source code block, for example, creating a JSON representation of the functionality implemented within the block. The system includes a block summary process 218 (shown in expanded form in FIGS. 4, expanded, and 5). Block summary process 218 is configured to use an LLM to automatically generate a summary of a source code block. The source code block for example is retrieved from source code blocks 204 to be operated on. The block summary process is adapted to create a prompt for submission to an LLM. The prompt is configured to request that the LLM prepare a summary in accordance with a set of specifications and an output data structure that is provided for in the prompt (or associated process). As discussed, a source code block may correspond to a feature. The feature describes the function from a user perspective, but the block summarizer process is configured to produce information about the intrinsic structure and operation of the source code block under its operation. For example, the block summarizer can generate the details of the input and output interfaces for that source code block. For example, the below provides a simplified example of a block summary generated by the block summarizer process by applying an LLM:
{
   “block_id”: 176,
   “block_name”: “bx_block_data_import_export”,
   “block_summary”: “The provided Ruby code directory is a data import/export module for a web application. It includes functionality for serializing account data, validating JSON web tokens, and handling data export requests in both JSON and CSV formats. The module also includes test specifications for the export functionality and a JSON Swagger file for API documentation. This could be used in any web application that requires secure data import/export functionality.”,
   “files”: [
      {
         “file_path”: “template-app/app/models/bx_block_data_import_export/application_record.rb”,
         “file_summary”: “This file defines the ApplicationRecord class in the BxBlockDataImportExport module, which inherits from BuilderBase::ApplicationRecord. It sets the abstract_class to true, indicating that this class should not be instantiated directly.”,
         “methods”: [ ]
      },
      {
         “file_path”: “template-app/app/serializers/bx_block_data_import_export/account_serializer.rb”,
         “file_summary”: “This file defines the AccountSerializer class in the BxBlockDataImportExport module, which inherits from BuilderBase::BaseSerializer. It specifies the attributes to be serialized for an account.”,
         “methods”: [
         {
         “method_name”: “AccountSerializer”,
         “method_summary”: “This class is a serializer for the Account model. It inherits from the BuilderBase::BaseSerializer class. It defines the attributes that will be serialized when an Account object is converted to a JSON format. The attributes include: activated, country_code, email, first_name, full_phone_number, last_name, phone_number, type, created_at, and updated_at.”
         }
      ]
   },
   {
      “file_path”: “template-app/app/controllers/bx_block_data_import_export/application_controller.rb”,
      “file_summary”: “This file defines the ApplicationController class in the BxBlockDataImportExport module, which inherits from BuilderBase::ApplicationController. It includes the Json WebToken Validation module from BuilderJson WebToken and defines a before_action to validate the JSON web token. It also defines a method to handle ActiveRecord::RecordNotFound exceptions.”,
      “methods”: [
         {
         “method_name”: “validate_json_web_token”,
         “method_summary”: “This is a before_action callback that is called before every action in the controller. It is used to validate the JSON Web Token (JWT) for the incoming request. The actual implementation of this method is not provided in this file.”
         },
         {
         “method_name”: “not_found”,
         “method_summary”: “This is a private method that is used as a rescue_from handler for ActiveRecord::RecordNotFound exceptions. When such an exception is raised, this method is called and it responds with a JSON object containing an error message ‘Record not found’ and a HTTP status code of 404 (not found).”
         }
      ]
   },
   {
      “file_path”: “template-app/app/controllers/bx_block_data_import_export/export_controller.rb”,
      “file_summary”: “This file defines the ExportController class in the BxBlockDataImportExport module, which inherits from ApplicationController. It defines an index action that generates a CSV file or a JSON response containing all accounts, depending on the request's content type.”,
      “methods”: [
         {
         “method_name”: “index”,
         “method_summary”: “This function is part of the ExportController in the BxBlockDataImportExport module. It checks the content type of the incoming request. If the content type is ‘text/csv’, it generates a CSV file with the column names of the AccountBlock::Account model as headers, excluding ‘password_digest’ and ‘unique_auth_id’. It then iterates over all the accounts in the AccountBlock::Account model, adding each account's attribute values to the CSV file. The CSV file is then sent as a downloadable file with the current date and time as the filename. If the content type is not ‘text/csv’, it fetches all the accounts from the AccountBlock::Account model and renders them as a JSON response using the AccountSerializer. The JSON response also includes a meta message ‘List of users.’ And a status code of 200 (OK).”
         }
      ]
   },
   {
      “file_path”: “template-app/spec/api/export_spec.rb”,
      “file_summary”: “This file contains the Rspec tests for the/bx_block_data_import_export endpoint. It tests the GET/data_import_export/export action with both JSON and CSV content types.”,
      “methods”: [ ]
   },
   {
      “file_path”: “swagger.json”,
      “file_summary”: “This is a Swagger file that documents the API for the bx_block_data_import_export block. It includes the/data_import_export/export endpoint, which supports a GET request that returns either a JSON or CSV response. The response schemas for both formats are defined in the components section.”,
      “methods”: [ ]
   },
   {
      “file_path”: “template-app/config/routes.rb”,
      “file_summary”: “All existing routes are added implicitly, but if any new route is added, it should be also added here to this file”,
      “methods”: [ ]
   }
]
}

Block summarizer process 218 is configured to summarize frontend and backend source code blocks and produce corresponding summaries for each.

Given a user story that has a particular functionality requirement and an existing block of code, the system can automatically determine the relevant areas of the code to be augmented/modified and automatically perform said changes. This may include refactoring existing code into a more optimized approach or potentially removing code that is no longer required. Implementation plan process 220 is configured to automatically “merge” the automated resources and knowledge contained in the structured data to apply it to a customer's project (by way of the customer's user story, understood to include one or more stories) and in response produce an implementation plan. An implementation plan is configured and stored in accordance with an implementation plan data structure. The implementation plan process 220, given a user story applied to a particular block, for example, determines which functionality needs to be added and to which files. In operation, the implementation plan process 220 operates on a new custom user story and is configured to retrieve the custom user story. “New” and/or “custom” when used with user story are being used to clarify or emphasize that the user story is at this stage of the overall process. The process 220 processes the custom user story (for the new project) to create an implementation plan for that custom user story by generating a prompt to the LLM. In operation, process 220 is configured to use data in the new custom user story, the block summaries, and source code blocks to automatically generate the implementation plan for that custom user story using the LLM. The user story is applied (using an LLM based process or knowledge graph based processing such as illustratively described in U.S. patent application Ser. No. 17/348,695 filed on Jun. 15, 2021, which is incorporated herein in its entirety) to the information about the source code blocks to select the source code blocks to use in the implementation plan. The user story is also applied (using an LLM based process) to the block summaries (for the selected source code blocks) to detect from the summary, modifications that are required to be made to the selected source code blocks to implement the software application for this user story. The detection will also identify where (e.g., which line(s) or location(s)) in a selected source code is to be modified. The process configures the LLM prompts to require the LLM to provide this identification in a structure that is compatible with the system for operation. The implementation plan is produced using the resulting operations. For example, the system is configured to generate a prompt for the LLM wherein the prompt contains the user story and the block summary. The implementation plan process 220 can have information about the source code blocks via the block summaries. In response, process 220 produces the implementation plan. The implementation plan is configured in accordance with an implementation plan data structure to carry the required information for the automated code generation and modification in the source code development process.

Backend code generation process 222 is configured to use the implementation plan to generate modified backend source code blocks. The process 222 uses the implementation plan to edit the source code in each block (block by block of those blocks involved in the application for that user story). The process can use information in API specifications for the backend source blocks, block architecture version, and/or documentation on guidelines in conjunction with the implementation plan to carry out the modification to the source code blocks. The process 222 generates a prompt to the LLM to accomplish the modifications (have the LLM generate the modifications). In response to the prompt, the LLM produces the modified code or instructions for the machine to update the code. The prompt can be engineered to include the applicable source code block, implementation plan and other stored or generated data (which is understood to include representations thereof).

Given a set of generated code blocks, a verification process is implemented that is configured to verify the functionality of the source code against a set of automated checks, such as security testing, static code analysis, unit tests, acceptance tests, etc., to produce a report indicating which of the generated code failed and which check(s), and produce an LLM prompt to regenerate/modify said code in such a way that it does now pass said check(s). The verify backend code process 224 is configured to receive the source code blocks (including the modified source code blocks produced using the implementation plan) and run static tests (mentioned above), tests the modified code (in isolation) through unit tests, and report what errors (if any) were raised. The produced object code is adapted to be operable on the designated operating system and/or central processing unit if applicable. The process 224 is configured to run the produced software in an environment that emulates the designated operating system and/or central processing unit. The environment provides a simulated test of the custom source code blocks (e.g., individually) in a controlled environment for evaluation. This can provide a simulation or emulation to test the operation on end devices that it is configured to operate on. Process 224 automatically monitors the process of compiling and running the software to detect and record errors. For example, if there is an error generated when the source code is compiled, the information associated with the error is recorded (such as the error code) and other related information is collected such as at which point through the compiler process was it triggered. Process 224 is configured to provide feedback (e.g., by way of messages or retrievable data) to the process 222.

Process 222 is configured to use the LLM and the error feedback from process 224 to automatically revise the source code block(s) to correct the error. For example, the prompt can be generated (understood to be automated) to be a combination of the error code and other collected information from process 224 in conjunction with the implementation plan and the selected source code blocks to generate revisions to the custom source code generated in the previous iteration.

Process 224 includes additional subprocesses configured to conduct different categories or types of testing or inspection that identify faults, weakness, or other issues. For example, a network software security test process can be applied to the source code or executable code and in response, the network security test process can identify certain faults or recommendations. Process 224 is also configured to send in a feedback cycle to the process 222 the results of the test or inspection process. In response to which, process 222 can be configured to automatically perform revisions to the source code to address the identified fault, weakness, or other issues in the feedback. The feedback can include related information form the testing that can be used in process 222 to create a prompt and/or perform the revisions.

The testing or inspection processes include custom/core validator process (to for example check whether the changes are made in permitted areas), SAST/DAST tools process (Scan of the generated code for newly introduced security vulnerabilities), code quality validation process (scan code to conduct code quality validation), build state status (fail/pass) process (this is a test of whether the code compiles correctly), and unit tests in block process.

The system is configured to integrated automated capture of unit tests for the custom software application. The process of creating the user story using prompts to the LLM can involve also prompting the LLM to identify requirements or unit tests that will confirm the user criteria. The user story can be provided to include or have associated therewith these criteria for evaluating and confirming the produced software application meets the desired operation(s). For example, the user story (based on user conversation with the user) can identify a criterion that the application is to allow the user to interact with a customer feedback interface and when completed the user is to be automatically taken to the community interface. The system can automatically generate a set of unit tests to validate whether the application meets these acceptance criteria and store the criteria. The test is then automatically applied in the unit testing process to monitor the generated software application. If for example, the generated software application does not move the user from the feedback interface to the community interface, an error is generated with a corresponding information specifying the related characteristics. The generated information from the failure can be sent through the feedback cycle to generate a revised version of the application.

The same process is performed for the fronted source code blocks for the user's custom software application.

Innovative systems, methods, and computer readable medium (computer executable instructions stored on non-volatile (non-transitory) memory that configured a computer to perform operations) are illustratively described herein.

Embodiments in which customers interact with the software development platform through their personal devices that interact with Internet based services (provided on servers) are described (such as by way of information incorporate by reference) but variations thereof are contemplated. A computer can include one or more computers (as is generally understood). It is also understood that it can incorporate or include services or systems that support the operation of the system such as a large language models.

A general objective of embodiments of the present invention is to provide fully automated computer generated capabilities.

The following figures provide examples of interactive GUIs (mentioned) above at part of the system as example ways of receiving and collecting information from customers. Additional ways can include receiving written text by the customer that is processed by a natural language process, having human representative(s) communicate with the customers (e.g., via video meeting) to (automatically) generate desired details of the customer application (and e.g., to generate a new user story), interacting with an expert automated assistance implemented on the system to collect the information (and e.g., to generate a user story), or other ways.

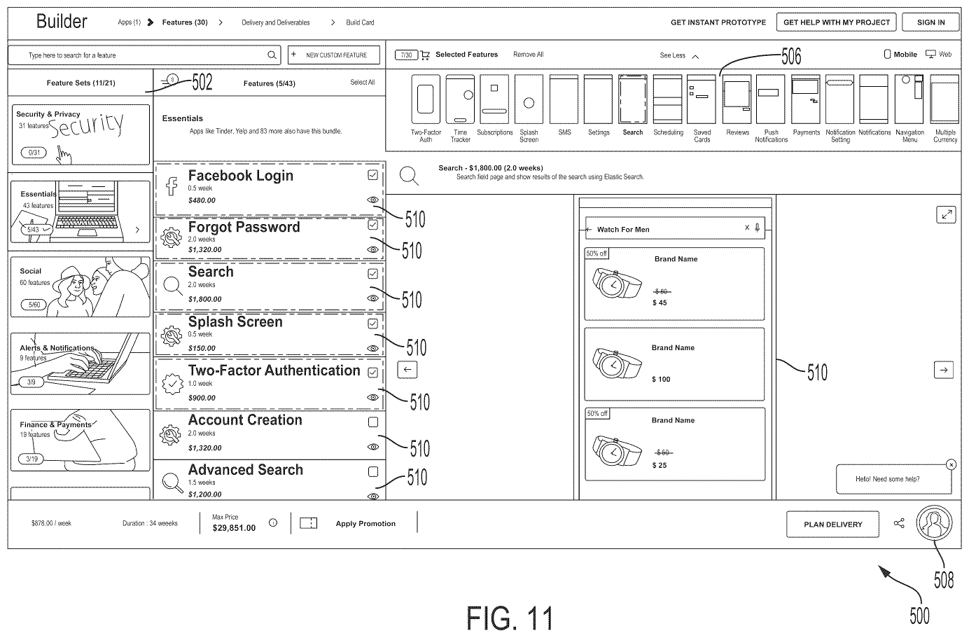

FIG. 11 illustrates an exemplary graphical user interface 500. The graphical user interface may be displayed in a web browser of a client computing device as part of a web page served by a server. The graphical user interface of embodiments of the present invention is configured to enable a user to select from a library of (disparate and/or distinct) software features 510 to build a software application.

The library of features 510 may be presented as a set of icons, a list, a drop down menu, or any other means of presenting information on graphical user interface. Graphical user interface 500 includes feature sets area 502 that displays a list of different feature sets such as security or social. In response to a user selecting one of the feature sets, the list of selectable features that are displayed adjacent to them are updated with the corresponding features in that set. Display area 506 displays an icon representation of each selected feature that comprises a miniaturized view of this what the corresponding display is represented to look like. Area 510 displays a selected one of the icons from 506 such that the user can view a larger view of feature by selecting from the different icons. Option 508 can activate an automated expert that assists the user including providing feature recommendations. A project can be specified and accepted by the user to contain a set of selected features (e.g., as a result of the selection of template, the features that defined the template are selected and added to the build card for the project). The user can interact with interface 500, for example, after initially selecting a template or problem in a previous screen to review and evaluate the features in the current build card and add new features from area 510 or remove features by interacting with 510 or 506. Interactive display area 506 identifies the selected features in the current build card and is configured to scroll laterally to allow the user to peruse the features if the screen is too small to show all of the features. Interface 500 may include a button or option such as expert option 508 that when selected in response display text that as one options displays one or more feature recommendations for the current project. In response to the user, selecting to add that recommended feature, the selected (recommended) feature can be added to the features to the current build card be displayed in interactive display area 506 and if “clicked” by a user, displayed in “zoomed” form in interactive display area (portion of display screen) 510. Using the interface 500, the user may be able to define all of the features that are to be contained in the current project. As mentioned, there may be other ways implemented (e.g., in combination with the web interface) to collect and store information about the characteristics or functionality that the user wants in the current project.

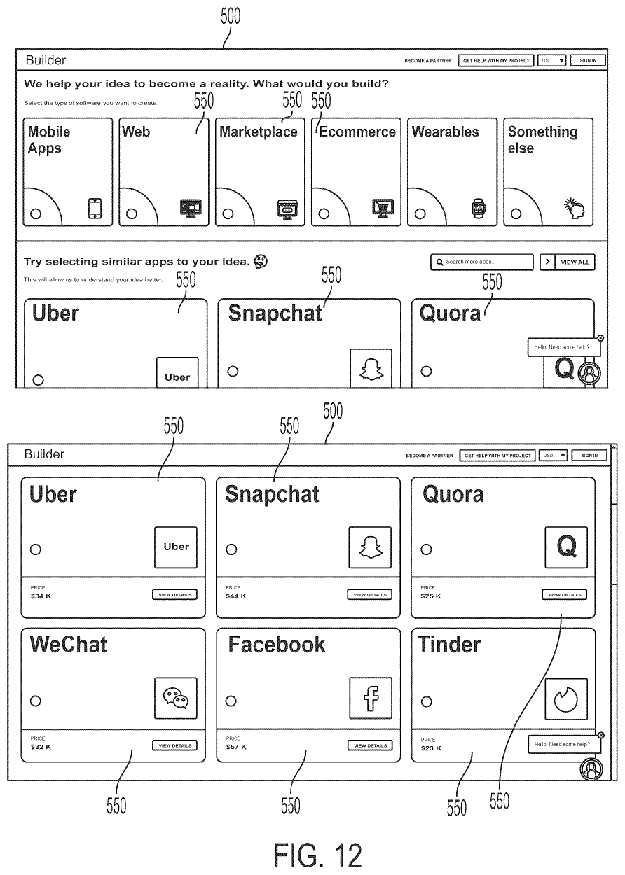

A template means a preorganized set of the library of features, which are available on the system as a way to associate particular template idea with set of curated features for that template. FIG. 12 illustrates graphical user interfaces 500 displaying a library of templates 550, according to an embodiment of the present invention. Each template 550 of the library provides the basic functional architecture and visual layout of the software project. In particular, the template 550 provides a predefined and customizable basic process flow process between a set of predefined and customizable features or functions of the software application. The library of templates 550 may be displayed on the graphical user interface 500 as a set of icons, a list, a drop down menu, or any other means of presenting a set of information on a graphical user interface.

In the embodiment illustrated, the templates 550 are grouped by types of software, such as mobile applications for mobile devices, web applications for website, marketplace applications that help buyers and sellers transact in real time, e-commerce application, applications for wearable devices such as apple watches or google wear, or any other types of applications that may be available on consumer devices. In the embodiment illustrated, the graphical user interface 500 further provides examples of templates within each grouping of templates. For example, the mobile application grouping may include a list of mobile application templates such as Uber, Snapchat, Quora, Tinder, or other popular mobile applications that a customer may want to use as a model to communicate requirements for their own application. A social media grouping for templates may include Facebook, Snapchat, Instagram, and templates of other social media applications. It should be noted that Applicant is not affiliated with the providers of the above applications and services whose structures may provide bases for templates in some embodiments.

After the user has selected a template 550, the user is provided with the opportunity to customize the software project by adding features to or removing features from the template (e.g., FIG. 2). In some embodiments, the interface may display a set of pre-selected additional features specifically corresponding to the template. For example, if the chosen template is that of a social media app, the user may be provided with additional relevant features such as Private Messages or Take Photo (in FIG. 11). Thus, the system enables the user to build software by either selecting features individually (e.g., “a la carte”) or selecting a predefined set of features or a template, building upon the template by adding or subtracting features to form the software project.

Referring back to FIG. 3, in some embodiments, the builder software 440 on the server 430 may further comprise process 485 which can comprise feature selector configured to select a set of features based on input from the user. In such embodiments, the client device 410 may prompt the user with various questions for specifying the type of software application and broad set of features desired, rather than presenting the user with a list of specific features. The feature selector 455 is configured to translate the user's input into a set of features to be integrated to form the target software application.

After the selection of features, or the selection of a template and if desired, a set of additional user-selected features for the template on the graphical user interface, the features are transmitted to the server 430 from the client computing device 410. As described above, the selection of features may also be generated by a feature selector that receives as input answers to prompts from the user interface and generates a selection of features therefrom. As mentioned other customization information can be received and incorporated into the code generation process.

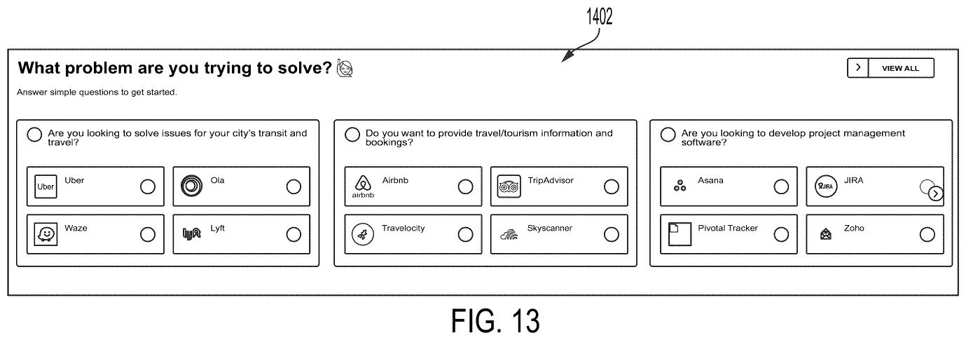

FIG. 13 illustrates an example of a portion of display screen that can be displayed to the user as part of the projects scope process. The platform can display areas that provide selectable problems (discussed above). The platform can then in response select the corresponding features that correspond to the selected problem. In this option, the platform can give the user to select/unselect templates within a problem before deciding to submit it as the user's selection.

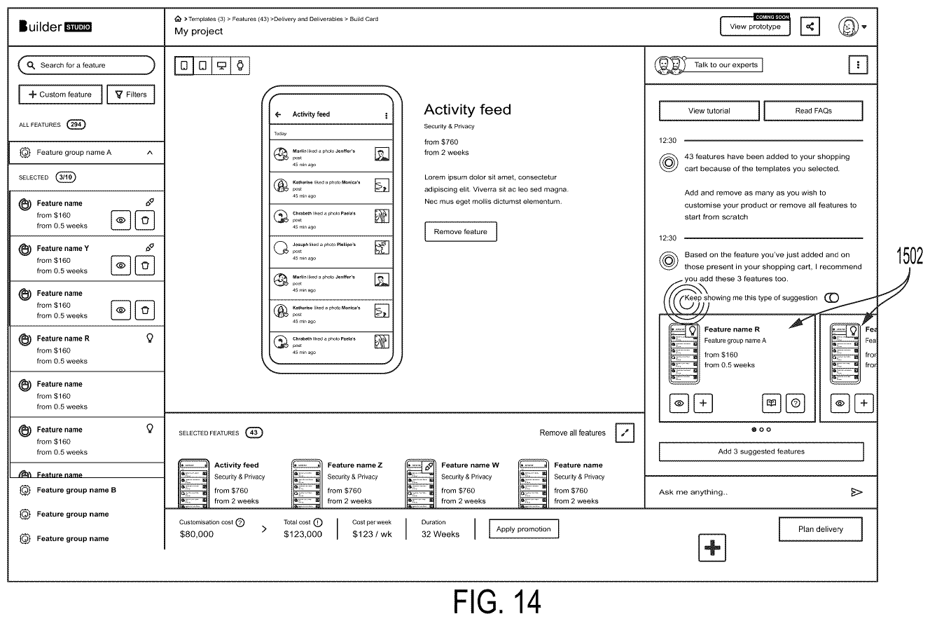

FIG. 14 illustrates that platform can be controlled to display selectable feature recommendations to the current user in the display screen in area 1502. In response to interactive with the expert assistance or other element as a button, the platform receives the results from the query based on the selected features of the user and displays one or more selectable features to the user. The display permits the user to select the one or more features and in response, adds the recommended features to the user's selected features in the design process. If the features are the approved or accepted, those set of features proceed in the platform to the next stage such as to generate source code.

In some embodiments, the platform is configured to automatically generate the software application or to combine the use of a developer to separately develop some desired code with the automatic code generation process of the system.

Automation of user story generation and acceptance criteria are next discussed. Given a conversation with a customer describing their idea such as through natural language voice interaction with an automated assistant (such as an automated assistant that operates using artificial intelligence to communicate with users in natural language), the system detects the features spoken about, determines specifically what requirements the customer has for each feature and then generate a set of feature notes, being a detailed description of all of the functionality that the customer expects from said feature. Then using the feature notes, the system automatically generates a set of user stories that can be given to a developer or code generation system to create the code. It also operates on the feature notes and/or user story to automatically generate a set of acceptance criteria that would be used by an automated quality assurance process, as part of the system, to validate the functionality of the developed source code with respect to the corresponding user story.

The software development platform can be configured to interact with the customer through the customer's device in one or more ways to receive the customer's idea This can include a natural language artificial intelligence voice assistant, text chat conversations with the platform such as through the assistant, email communications with the platform, meetings (recorded audio or video) during which the customer discusses their project (for example to platform personnel), GUI interfaces structured to allow the user to select or indicate features, feature relationships, application type, or other aspects in a structured way provided by the GUI interfaces, or other form of communication with the customer (including any combinations thereof).

The software development platform can include a code generation system such as the code generation process illustratively described herein. The code generation system is configured to use a structured process to automatically generate code (source code blocks or entire combination of blocks that form the software application for the project). The user story can be an input to the code generation system in response to which the code generation system generates the code for the custom software application desired by the customer. The user story is generated by the system using a process that is adapted to make it both human-readable and machine-readable by the code generation system to operably communicate (without human intervention) the data for the code generation system.

As mentioned, the customer may have one or more different electronic communications with the platform. For example, they may have a call with product managers or there may be multiple system monitored/recorded customer interactions. The system is configured to receive and record one or more of these different types of communications and the system is configured to have one or more processes that analyze the one or more communications (or representations thereof), communicating about the customer's idea, discussing how the customer wants certain content, flow, function, or interaction. The system is configured to include processes that reviews the recorded conversations and automatically identifies which features the customer desires for the project. At a high level, the software development platform is configured to store a defined library of features and related data for each feature. The automated analysis by the processes is configured to automatically identify (through the various modes of communication) matching features in the software development platform and the customizations and/or extensions needed to these to deliver the customer's requirements. The system is configured to tag the communication (such as the portion of the electronic communication that triggered the system to match it with the feature) with a tag specifying the feature.

The system is configured to generate data in connection with the tagged feature that is adapted to represent feature-related information shared by the customer. The generated data is configured to characterize the surrounding context of the conversation into data further characterizing the context, operation, requirement, user, or other related operation of the feature. This is referred to as a feature note.

The system can be configured to produce the feature note to be a textual description of what the customer “said” about this feature. For example, if the customer discussed about the login screen 10 times (in one or more interactions with the automated assistant and/or with platform personnel), the system is configured to generate the feature note for the login screen and to include what the customer communicated about that feature, the login screen.

The system is further configured to automatically generate a user story using the feature notes generated from the communications with the customer. In operation, the system is configured to generate a prompt to submit to an LLM. The prompt is generated by the system automatically using an algorithm that retrieves the feature notes and generates the user story for a project to develop a new custom software application for a customer. For example, the system generates the prompt to include the feature notes (understood to include portions thereof and/or processed portions thereof). The LLM using the engineered prompt generates a user story for that new custom software application project.

These custom user stories are defined and stored in accordance with a defined custom user stories data structure. The information stored in the custom user stories database defines the individual customer user stories. A user story is a structured description that is generated by the system from receiving one or more types of input from a user seeking a custom software application to be designed and developed for them by the system. For example, as mentioned, the platform can include an artificial intelligence assistant that is configured to allow the user to interact with the assistant by typing in information such as in an online chat dialogue or speaking in natural language with the artificial intelligence assistant (e.g., through the microphone on the user's computer). The system is configured to receive such input and generate a custom user story from the received input for that user's desired custom software application. The custom user story is generated and stored in accordance with the custom user stories data structure such that information stored for the user story is automatically operable with other coordinating processes in the platform.

The user story is configured to be human and machine-readable by the system. With respect to the latter, the system may be configured to use the user story and apply it as an input to the code generation system (without requiring human intervention, modification, and/or review). The user story can be automatically inserted into the code generation system to generate the software application (including source code blocks) in accordance with the generated user story.

The system using the process is configured to automatically find features described in a customer “conversation” and extract related information desired by the customer for the found feature(s). The system captures the automatically generated data in feature notes, which are processed using an engineered prompt by an LLM to convert the features notes for a desired custom software application into a set of user stories.

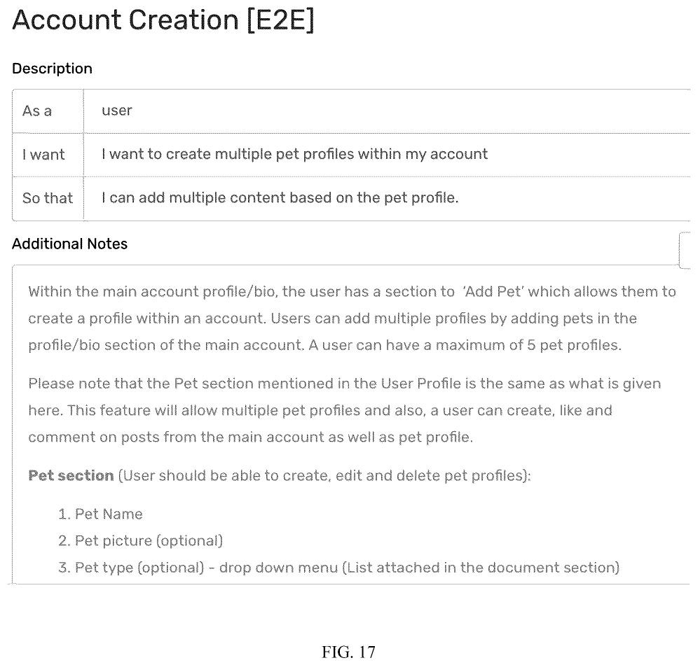

The process is configured to convert unstructured “conversations” (or combination of structured and unstructured “conversations”) into a description, a user story. An example of a manually produced user story is provided in FIG. 17 which is illustrative in structure and content of an automatically generated user story. The user story is a representation of the desired software application or portions or aspects thereof but it is not itself source code or source code blocks. As discussed, the system is configured to automatically machine-generate the user story.

The system is configured to apply the user story for a custom application to automatically generate other related (and supporting) capabilities in the software development platform.

In some implementations, the system is configured to retrieve and use the user story to automatically generate acceptance criteria (or other tests that validate the source code blocks) such as by the quality assurance (QA) processes (e.g., tests automatically generated using the criteria) to determine acceptance of the application in accordance with the customer's direction. The system is configured to generate a prompt for the LLM comprising or using the user story and in response to the structured prompt, the LLM generates a plurality of acceptance criteria such as in human readable form. The system can save the acceptance criteria and provide the criteria to the QA process. These can for example specific tasks that the QA process should perform in accordance with the specified criteria when the executable version of the desired software application is being tested (by humans or using an automated testing environment). For example, if the customer communicated about the sequence of operation from the login screen being to a message screen, the user story would have captured that information and the processes for acceptance criteria would also detect that and convert it into a task for QA process that checks whether the executable software (or the source code prior to executable form) is structured to follow the user story (login screen to messages screen). Any (e.g., one or more) failure (an error message) would trigger a subsequent process to revise the application.

The system can be configured to include a process (an automated computer process, which would be understood throughout) that structures or modifies the user story (once generated) to sequence (maintain sequencing), identify contradictions, or other logic. A process can be implemented that for example uses a set of rules and/or LLM to detect whether the customer stated inconsistent feature information, such as stating that a certain flow should occur in one way but later in a subsequent meeting communicating the flow differently. The process can also assist in structuring the user notes and merging notes in support of user story generation. This process can trigger communication with the customer or other trigger other operations.

The software development platform can be configured to include a tracker or monitor process that operates as a tool to capture and record conversations and trigger related operations when certain events are detected by the tracker process. For example, in the event that a human product assistant prepares a written note from a conversation with a customer for a project and saves it. This event triggers the tracker to retrieve the written note and generate and/or update a feature note for that customer's project. This trigger can also occur when the system automatically recorded information from a conversation to automatically generate a feature note. These triggers and resulting feature notes create a pipeline of content (and corresponding tasks) that the system can convert into a user story for the project.

As discussed, feature notes are sets of notes, specific to a feature that can then be (automatically) used by downstream processes and tools. The system is configured to create one or more user stories from a feature's notes.

User stories are objects that are recorded in a tracker process (or more broadly in processes or systems that include the tracker process). A single feature may have several user stories associated with it.

In implementation with the system, in some embodiments, user stories can be in one of 3 states: draft, accepted, rejected. Changing the state is something that can be performed automatically or by human product assistants using a tracker user interface.

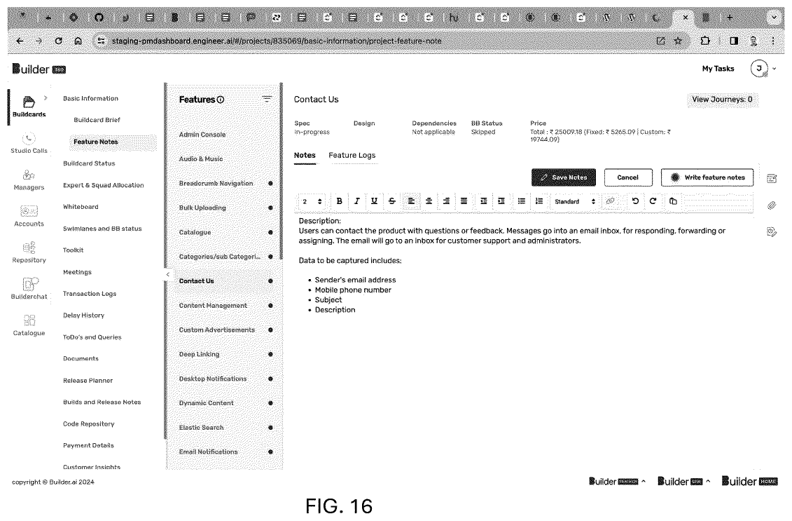

FIG. 16 is an example of a display screen implemented by the system that permits a human product assistant to document notes for a project and save the notes.

The action of clicking on Save Notes will trigger creation of user stories for that feature in the tracker process. Any new user stories that are created through this process will start in a draft state. At this point, the tracker can trigger a call to a user story generation process. From a single feature, one or more user stories may be created by the system.

In order for the system to generate new user stories, additional context will be passed to the supporting API such as feature notes (existing notes for the feature and the newly created notes) and existing accepted user stories associated with the feature.

The system using the API is configured to check if there is already a user story that covers the feature note; if this is the case, then no updates are made to that user story, and automated assistant moves on to the next one. The only user stories considered here are ones that are those in the accepted state (draft and rejected ones are not considered).

Assuming that one or more user stories were returned by the system using the API, these will then be automatically created in the tracker for that project (in draft state).

The user story generation can be a computationally intensive task (as it uses LLMs for text generation) so may be run as batch process with an asynchronous response to flag when the user story generation is completed.

As such, the system is configured to implement a structured process to generate feature notes, user stories, and related acceptance criteria as part of the of the software development platform. This can provide more an accurate and efficient process (among other benefits) for generating a software application.

The structured prompts for the LLM can be in a form or content that is not natural language (understandable as sentences or phrases) because the LLM can successfully process such input.

Innovative systems, methods, and computer readable medium (computer executable instructions stored on non-volatile (non-transitory) memory that configured a computer to performs operations) are illustratively described herein.

Embodiments are described in which customers interact with the software development platform through their personal devices that communicate with Internet based services (provided on servers) (such as by way of information incorporated by reference) but variations thereof are contemplated. A computer can include one or more computers (as is generally understood). It is also understood that it can incorporate or include services or systems that support the operation of the system such as a large language model (generative AI).

One of the general objectives of embodiments of the present invention is to extract (and store) from the customer communications (and notes) rationale for, or why a feature is desired by the customer. This extracted information can assist in the automated code generation process such as one involving generative output of a large language model when generating user stories or related features.

It should be understood that variations, clarifications, or modifications are contemplated. Applications of the technology to other fields are also contemplated.

Each of the system, server, computing device, and computer described in this application can be implemented on one or more computer systems and be configured to communicate over a network. In one embodiment, the computer system includes a bus or other communication mechanism for communicating information, and a hardware processor coupled with bus for processing information.

The computer system also includes a main memory, such as a random access memory (RAM) or other dynamic storage device, coupled to bus for storing information and instructions to be executed by a processor of the computer or computing device. Main memory also may be used for storing temporary variables or other intermediate information during execution of instructions to be executed by a processor. Such instructions, when stored in non-transitory storage media accessible to processor, configure the computer system into a special-purpose machine that is customized to perform the operations specified in the instructions and provide or be capable of features and functionality described herein. The processes described herein can be implemented as computer instructions executable by the processor of a computer or computing device to perform described process steps. The computer instructions can be saved on nonvolatile or nontransitory memory for providing such implementations.

The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as an LCD, for displaying information to a computer user. An input device, including alphanumeric and other keys, may be coupled to bus for communicating information and command selections to processor. Another type of user input device is cursor control, such as a mouse, a trackball, touchscreen (e.g., on mobile phones) or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which, in combination with the computer system, causes or programs the computer system to provide specialized features. According to one embodiment, the techniques herein are performed by the computer system in response to the processor executing one or more sequences of one or more instructions contained in main memory. Such instructions may be read into main memory from another storage medium, such as a storage device. Execution of the sequences of instructions contained in main memory causes the processor to perform the process steps described herein. In alternative embodiments, hard-wired circuitry may be used in place of or in combination with software instructions.

The term storage media as used herein refers to any non-transitory media that stores data and/or instructions that cause a machine to operate in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid state drive of a remote computer. A bus carries the data to the main memory, from which the processor retrieves and executes the instructions. The instructions received by the main memory may optionally be stored on a storage device either before or after execution by the processor.

The computer system also includes a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on the network link and through the communication interface, which carry the digital data to and from the computer system, are example forms of transmission media.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It should be understood that variations, clarifications, or modifications are contemplated. Applications of the technology to other fields are also contemplated.

It is understood from the above description that the functionality and features of the systems, devices, or methods of embodiments of the present invention include generating and sending signals to accomplish the actions.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

What is claimed is:

1. A software development system for assisting users seeking a custom software application, comprising,
a computer configured to track user interactions with the customer in connection with the customer communicating the customer's desired software applications and determine one or more predefined features, for the application, determined to be reflected in the interactions, generate feature notes about the one or more determined features from the interaction, and automatically generate one or more user stories from the generated feature notes for the corresponding predefined feature.
